(19) United States
(12) Patent Application Publication
(10) Pub. No.: US 2024/0279253 A1
(43) Pub. Date: Aug. 22, 2024

(54) METHOD FOR MAKING AN ASYMMETRIC (METH)ACRYLATE FUNCTIONAL DISILOXANE

(71) Applicant: Dow Silicones Corporation, Midland, MI (US)

(72) Inventors: Xiaoyuan Zhou, Midland, MI (US); Eric Joffre, Midland, MI (US)

(21) Appl. No.: 18/559,877

(22) PCT Filed: Jul. 21, 2022
(86) PCT No.: PCT/US2022/073980

§ 371 Date: Nov. 9, 2023

Related U.S. Application Data
(60) Provisional application No. 63/234,948, filed on Aug. 19, 2021.

(51) Int. Cl. C07F 7/08

(52) U.S. Cl. CPC C07F 7/0874

(57) ABSTRACT

A cohydrolysis method is used to prepare an asymmetric (meth)acrylate-functional diorganosiloxane from a (meth)acryl-functional silane, a diorganohydridohalosilane, and water.

### CROSS REFERENCE TO RELATED APPLICATIONS

This application claims the benefit of U.S. Provisional Patent Application Ser. No. 63/234,948 filed on 19 Aug. 2021 under 35 U.S.C. § 119 (e). U.S. Provisional Patent Application Ser. No. 63/234,948 is hereby incorporated by reference.

### TECHNICAL FIELD

This invention relates to a method for making an asymmetric (meth)acrylate-functional diorganosiloxane. More particularly, this invention relates to a method for making an α-hydrido, ω-(meth)acryl-terminated diorganosiloxane oligomer.

### INTRODUCTION

Asymmetric diorganosiloxanes containing both silicon hydride and (meth)acryl-functionalities such as SiHMA are useful as versatile building blocks for the production of silicon-based and silicon-modified polymers and resins that can undergo free radical polymerization. These free radical polymerizable materials can be used in numerous industrial fields, including building, automotive, home care, and personal care.

The preparative methods for SiHMA are limited. European Patent 3 387 045 B1 discloses a method for making an acrylate functional diorganosiloxane via hydrosilylation reaction of an organohydrogensiloxane oligomer and a carboxylic acid alkenyl ester, in the presence of a hydrosilylation reaction catalyst. The hydrosilylation reaction catalyst is an iridium complex. There is an industry need for improved and less costly methods for preparing asymmetric disiloxanes, such as SiHMA, that do not use expensive hydrosilylation reaction catalysts.

### SUMMARY

A method for making an asymmetric (meth)acrylate-functional diorganosiloxane comprises: cohydrolysis of starting materials comprising: (A) a (meth)acryl-functional silane of formula R¹R²₂SiX, where each R¹ is an independently selected (meth)acryloxyalkyl group, each R² is an independently selected alkyl group, and each X is independently selected from the group consisting of halogen and alkoxy; (B) a diorganohydridohalosilane of formula R²₂HSiX, where R² and X are as described above, and (C) water.

### DETAILED DESCRIPTION

The starting materials used in the method described herein include: (A) the (meth)acryl-functional silane of formula R¹R²₂SiX, where R¹ is a (meth)acryloxyalkyl group, each R² is an independently selected alkyl group, and X is selected from a halogen or alkoxy; (B) the diorganohydridohalosilane of formula R²₂HSiX, and (C) water.

### (A) (Meth)Acryl-Functional Silane

The (meth)acryl-functional silane has formula R¹R²₂SiX, where R¹ is an independently selected (meth)acryloxyalkyl group, each R² is an independently selected alkyl group, and each X is independently selected from halogen or alkoxy. The (meth)acryloxyalkyl group for R¹ may have formula:

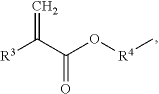

where R³ is selected from the group consisting of H and methyl, and R⁴ is an alkane-diyl group. Suitable groups for R⁴ may be an alkane-diyl group 2 to 6 carbon atoms. Alternatively, R⁴ may be ethane-1,2-diyl, propane-1,2-diyl, propane-1,3-diyl, butane-1,4-diyl, or hexane-1,6-diyl; and alternatively R⁴ may be ethane-1,2-diyl or propane-1,3-diyl. Alternatively, the (meth)acryloxyalkyl group for R¹ may be selected from the group consisting of 3-methacryloxypropyl and 3-acryloxypropyl.

The monovalent hydrocarbon group for R² may be an alkyl group or an aryl group. Suitable alkyl groups for R² are exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, as well as branched saturated hydrocarbon groups of 6 carbon atoms. Alternatively, the alkyl group for R² may be methyl, ethyl or propyl. Suitable aryl groups for R² are exemplified by, but not limited to, phenyl, tolyl, xylyl, benzyl, and 2-phenylethyl. Alternatively, R² may be a methyl group or a phenyl group. Alternatively, each R² may be methyl.

The halogen for X may be selected from the group consisting of bromine (Br), chlorine (Cl), fluorine (F), and iodine (I). Alternatively, X may be selected from the group consisting of Br, Cl, and I. Alternatively, X may be selected from the group consisting of Br, Cl, and F. Alternatively, X may be selected from the group consisting of Br and Cl. Alternatively, each X may be Cl. Alternatively, X may be an alkoxy group, such as an alkoxy group of 1 to 4 carbon atoms. Alternatively, X may be selected from the group consisting of methoxy, ethoxy, propoxy, isopropoxy and butoxy.

Starting material (A) may be one (meth)acryl-functional silane or a combination of two or more (meth)acryl-functional silanes that differ from one another in at least one property, e.g., selection of group R¹, selection of group R², and/or selection of X. (Meth)acryl-functional silanes are known in the art. (Meth)acryl-functional silanes, such as 3-methacryloxypropyldimethylchlorosilane of formula

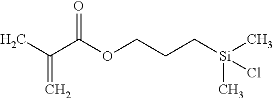

and 3-methacryloxypropyldimethylmethoxysilane of formula

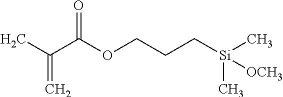

are commercially available, e.g., from Gelest Inc. of Morrisville, Pennsylvania, USA.

### (B) Diorganohydridohalosilane

The diorganohydridohalosilane used in the method has formula R²₂HSiX, where R² and X are as described above. Examples of suitable diorganohydridohalosilanes include dimethylchlorosilane (Me₂HSiCl), dimethylbromosilane (Me₂HSiBr), diethylchlorosilane (Et₂HSiCl), and diethylbromosilane (Et₂HSiBr). Alternatively, the diorganohydridohalosilane may be dimethylchlorosilane.

Diorganohydridohalosilanes are known in the art, may be made by known methods such as the Direct Process, and are commercially available. For example, dimethylhydridochlorosilane is available from various sources including DSC and Gelest Inc. Starting material (B) may be one diorganohydridohalosilane or a combination of two or more diorganohydridohalosilanes that differ from one another in at least one property, e.g., selection of group R², and/or selection of X.

The amount of starting materials (A) and (B) depends on various factors including the species of each selected and the desired asymmetric (meth)acrylate-functional diorganosiloxane to be produced, however, the amounts of (A) the (meth)acryl-functional silane and (B) the diorganohydridohalosilane may be sufficient to provide a molar ratio (A): (B) of 1:1.2 to 1:3. Alternatively, the amounts of (A) and (B) may be sufficient to provide a molar ratio (A): (B) of 1:1 to 1:10.

### (C) Water

The water used in the method described herein is not generally limited, and may be utilized neat (i.e., absent any carrier vehicles/solvents), and/or pure (i.e., free from or substantially free from minerals and/or other impurities). For example, the water may be processed or unprocessed prior to the cohydrolysis reaction with the halosilanes described above, i.e., starting materials (A) and (B). Examples of processes that may be used for purifying the water include distilling, filtering, deionizing, and combinations of two or more thereof, such that the water may be deionized, distilled, and/or filtered. Alternatively, the water may be unprocessed (e.g. may be tap water, i.e., provided by a municipal water system or well water, used without further purification). Alternatively, the water may be purified before the cohydrolysis reaction with the halosilanes.

The water may be utilized in any amount, which will be selected by one of skill in the art, depending on various factors, e.g., the particular species of halosilanes (A) and (B) selected, the reaction parameters employed, and the scale of the reaction (e.g. total amount of starting materials (A) and (B) to be cohydrolyzed).

### Cohydrolysis Product

The asymmetric (meth)acrylate-functional diorganosiloxane in the cohydrolysis product prepared by the method described above may have formula:

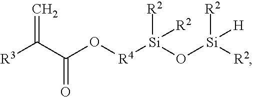

where R², R³, and R⁴ are as described above.

The cohydrolysis product may further comprise side product selected from the group consisting of

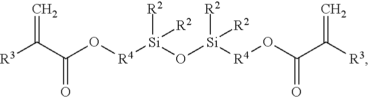

or a combination of both, where R², R³, and R⁴ are as described above.

### Method Steps

The method for making the asymmetric (meth)acrylate-functional diorganosiloxane comprises: (1) cohydrolysis of starting materials in a single reactor, where the starting materials consist essentially of (A) the (meth)acryl-functional silane; (B) the diorganohydridohalosilane, and (C) water; thereby forming the cohydrolysis product comprising the asymmetric (meth)acrylate-functional diorganosiloxane and the side product, where starting materials (A), (B), and (C), and the asymmetric (meth)acrylate-functional diorganosiloxane and the side product are as described above. The reactor is not particularly restricted and may be any batch or continuous reactor capable of maintaining a temperature of >0 to <10° C. during the cohydrolysis reaction in step (1). In step (1), (A) the (meth)acryl-functional silane and (B) the diorganohydridohalosilane may be added to (C) the water over a period of time, e.g. by metering in separate streams of (A) and (B) into a batch reactor, such as a jacketed kettle, or by combining (A) and (B) to form a mixture of halosilanes that may be metered into the reactor. Step (1) forms a product comprising a siloxane layer and an aqueous layer, which phase separate. The siloxane layer comprises a cohydrolysis product comprising the asymmetric (meth)acrylate-functional diorganosiloxane and a side product.

The method may optionally further comprise: (2) separating the siloxane and aqueous layers, and washing the cohydrolysis product with additional water after step (1). The additional water is as described above for starting material (C). The method may optionally further comprise (3) adding (D) a neutralizing agent during or after step (2). The neutralizing agent may be, for example, sodium bicarbonate, sodium carbonate, sodium hydroxide, potassium bicarbonate, potassium carbonate, potassium hydroxide, or a combination thereof. Alternatively, the neutralizing agent may be NaHCO₃.

The method may optionally further comprise one or more additional steps to purify the asymmetric (meth)acrylate-functional diorganosiloxane, recover the side product and/or remove any undesired materials in the cohydrolysis product. For example, the method of may further comprise drying the cohydrolysis product after step (1), or after step (2) and/or (3) when present, to remove all or a portion of residual water. Drying may be performed by any convenient means such as adding an absorbent or adsorbent. Examples of drying agents may be inorganic particulates. The adsorbent may have a particle size of 10 micrometers or less, alternatively 5 micrometers or less. The adsorbent may have average pore size sufficient to adsorb water and alcohols, for example 10 Å (Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof. Alternatively, the drying agent may be sodium sulfate or activated carbon.

Examples of commercially available drying agents include dry molecular sieves, such as 3 Å (Angstrom) molecular sieves, which are commercially available from Grace Davidson under the trademark SYLOSIV™ and from Zeochem of Louisville, Kentucky, U.S.A. under the trade name PURMOL, and 4 Å molecular sieves such as Doucil zeolite 4A available from Ineos Silicas of Warrington, England. Other useful molecular sieves include MOLSIV ADSORBENT TYPE 13X, 3A, 4A, and 5A, all of which are commercially available from UOP of Illinois, U.S.A.; SILIPORITE NK 30AP and 65xP from Atofina of Philadelphia, Pennsylvania, U.S.A.; and molecular sieves available from W. R. Grace of Maryland, U.S.A.

The method may optionally further comprise filtering the cohydrolysis product, after any one or more of the steps described above to remove, e.g., the drying agent, when used, and any salts formed during neutralization.

The method may optionally further comprise stripping or distilling the cohydrolysis product. Stripping and/or distillation may be used to purify the asymmetric (meth)acrylate-functional diorganosiloxane described above and/or a side product, such as the side product selected from the group consisting of

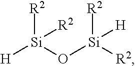

as described above. Without wishing to be bound by theory, it is thought that one or both of the side products may be recycled and/or used in other processes.

### Method of Use

The asymmetric (meth)acrylate-functional diorganosiloxane described above may be used for the production of silicon-based and silicon-modified polymers and resins that can undergo free radical polymerization. These free radical polymerizable materials can be used in numerous industrial fields, including building, automotive, home care, and personal care. For example, U.S. Pat. No. 9,587,063 describes the use of 2-propenoic acid, 2-methyl, 3-(1,1,3,3-tetramethyl-1-1disiloxanyl)propyl ester (SiHMA) for the preparation of asymmetric-telechelic polydihydrocarbylsiloxane. U.S. Pat. No. 4,504,629 described the use of SiHMA as a grafting agent to make methacrylate functional graft polymers that can be cured or co-cured with other vinyl monomers under less sever conditions using UV, peroxide, anaerobic or other radical curing systems. Japan Patent Application 2012121950A described the use of SiHMA as monomer for the preparation of silicone modified poly(meth)acrylic acid ester to make hybrid materials having improved toughness and thermal stability. European Patent Application 3594263A1 described an oxygen-curable silicone composition containing a methacryloyloxy terminated PDMS that was made from SiHMA and vinyl terminated PDMS. The asymmetric (meth)acrylate-functional diorganosiloxane prepared described herein may be used in these applications.

### EXAMPLES

These examples are provided to illustrate the invention to one skilled in the art and are not to be construed to limit the scope of the invention set forth in the claims. Starting materials used in these examples are described below in Table 1.

| Starting | | |
|---|---|---|
| Material | Chemical Description | Source |
| MASiMe₂Cl | 3-Methacryloxypropyldimethylchlorosilane | Gelest |
| MASiMe₂OMe | 3-Methacryloxypropyldimethylmethoxysilane | Gelest |
| Me₂HSiCl | Dimethylchlorosilane | Acros |
| DI H₂O | Deionized water | |
| NaHCO₃ | Sodium bicarbonate | Sigma- |
| | | Aldrich |
| | Sodium sulfate | Sigma- |
| | | Aldrich |

In this example 1, preparation of SiHMA from the co-hydrolysis of MASiMe₂Cl and Me₂HSiCl was performed according to Reaction Scheme 1, using a ratio of MASiMe₂Cl:Me₂HSiCl=1:3, as follows.

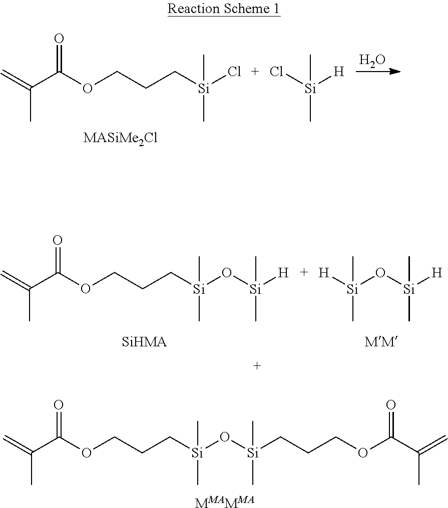

A 100 mL 3-neck flask, fit with a thermal couple, an addition funnel, and an outlet connected to an aqueous NaOH scrubber, was charged with DI H₂O (15.5 g) and immersed in an ice/water bath. The system was purged with nitrogen. 3-methacryloxypropyldimethylchlorosilane (MASiMe₂Cl, 10.0 g, 0.045 mol) and dimethylchlorosilane (Me₂HSiCl, 12.9 g, 0.136 mol) were mixed in a glovebox and transferred to the addition funnel via a syringe under inert condition. From the addition funnel, the mixture of the chlorosilanes were added to 5° C. water dropwise upon vigorous stirring over 20 min during which the reaction temperature was kept below 10° C. After addition, the resulting 2-layer mixture was stirred at ca. 5° C. for another 15 min before separation. The siloxane layer was washed with saturated NaHCO₃ (15 g) twice, followed by DI H₂O (15 g) wash twice, until pH reached neutral. The siloxane layer was then dried with sodium sulfate and filtered to give a clear yellow filtrate (9.6 g). GC analysis showed that the cohydrolysis product contained SiHMA (74.4%), M′M′ (14.0%), and MMAMMA (2.2%). The cohydrolysis product was then stripped under vacuum to give the stripped product (6.9 g) which was characterized by GC and 1H NMR. The stripped product contained SiHMA (78.4%), M′M′ (0.7%), and MMAMMA (2.7%), based on GC. 1H NMR (CDCl₃): δ 6.16 (m, 1H), 5.22 (m, 1H), 4.94 (m, 1H), 4.05 (t, 2H), 1.86 (s, 3H), 1.58 (m, 2H), 0.45 (m, 2H), 0.13 (s, 6H), 0.0 (s, 6H).

In this example 2, preparation of SiHMA from the co-hydrolysis of MASiMe₂Cl and Me₂HSiCl was performed according to Reaction Scheme 1, using a ratio of MASiMe₂Cl:Me₂HSiCl=1:1.2. The procedure of Example 1 was repeated except for the following. The 3-methacryloxypropyldimethylchlorosilane (MASiMe₂Cl) in an amount of 10.0 g (0.045 mol) and dimethylchlorosilane (Me₂HSiCl) in an amount of 5.1 g (0.054 mol) were mixed in the glovebox and transferred to the addition funnel. After addition of the mixture of chlorosilanes, the resulting 2-layer mixture was stirred at ca. 5° C. for another 1 h before separation. And, after filtration, a clear yellow filtrate in an amount of 9.5 g was obtained. GC analysis showed that the crude product contained SiHMA (74.6%), M′M′ (0.41%), and M^{MA}M^{MA} (10.9%). The cohydrolysis product was then stripped under vacuum to give the stripped product (9.1 g) which was characterized by GC and 1H NMR. The stripped product contained SiHMA (75.4%), M′M′ (0.35%), and MMAMMA (10.6%), based on GC.

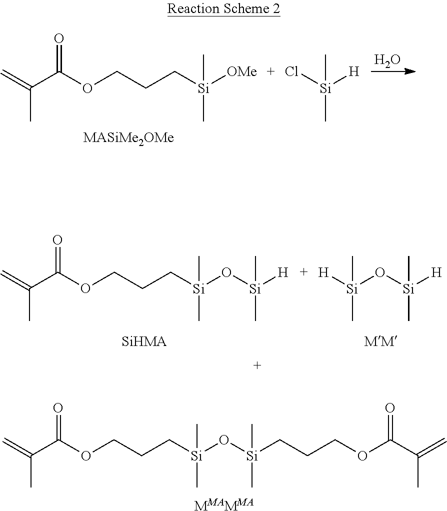

In this example 3, preparation of SiHMA from the co-hydrolysis of MASiMe₂OMe and Me₂HSiCl was performed according to Reaction Scheme 2, using a weight ratio of MASiMe₂OMe:Me₂HSiCl=1:1.2. The procedure of Example 1 was repeated except for the following. The 3-methacryloxypropyldimethylmethoxysilane (MASiMe₂OMe) in an amount of 10.0 g (0.046 mol) and dimethylchlorosilane (Me₂HSiCl) in an amount of 5.2 g (0.055 mol) were mixed in the glovebox and transferred to the addition funnel. After addition of the mixture of chlorosilanes to water in an amount of 15.8 g, the resulting 2-layer mixture was stirred at ca. 5° C. for another 1 h before separation. And, after filtration, a clear colorless filtrate in an amount of 9.7 g was obtained. GC analysis showed that the crude product contained SiHMA (85.8%), M′M′ (0.46%), and MMAMMA (10.7%). The cohydrolysis product was then stripped under vacuum to give the stripped product (9.4 g) which was characterized by GC and 1H NMR. The stripped product contained SiHMA (85.4%), M′M′ (0.26%), and MMAMMA (10.5%), based on GC.

In this example 4, preparation of SiHMA from the co-hydrolysis of MASiMe₂OMe and Me₂HSiCl was performed according to Reaction Scheme 2, using a ratio of MASiMe₂OMe:Me₂HSiCl=1:3. The procedure of Example 1 was repeated except for the following. The 3-methacryloxypropyldimethylmethoxysilane (MASiMe₂OMe) in an amount of 50.0 g (0.231 mol) and dimethylchlorosilane (Me₂HSiCl) in an amount of 65.6 g (0.693 mol) were mixed in the glovebox and transferred to the addition funnel. After addition of the mixture of chlorosilanes to water in an amount of 79 g, the resulting 2-layer mixture was stirred at ca. 5° C. for another 15 min before separation. And, after filtration, a clear colorless filtrate in an amount of 76.7 g was obtained. GC analysis showed that the crude product contained SiHMA (80.8%), M′M′ (16.1%), and MMAMMA (1.6%).

Distillation of the crude in example 4. A short path distillation set-up was used. Crude SiHMA from example 4 (20 g) was loaded into a 50 mL RB flask. Vacuum was applied to reduce the pressure to 1 mmHg and kept at this level. The flask was heated at 69-71° C. for 1 h to collect the low boilers. The residual material was further distilled under <0.1 mmHg at 77-89° ° C. for about 1.5 h and a clear distillate (SiHMA) was collected. The bottoms were a clear liquid without any gelation, suggesting good stability of the material made from the cohydrolysis route. 14 g SiHMA (98% pure) was obtained, with a yield of 70%, and characterized by GC and 1H NMR, as shown in Table 2, below.

TABLE 2

| | Reboiler T (° C.) | Head T(° C.) | Weight (g) |
|---|---|---|---|
| Low boilers | Up to 70 | Up to 23 | 3.3 |
| SiHMA | 77-89 | 69-72 | 14.0 |
| Bottoms | | | 0.54 |

Comparative example. A short path distillation set-up was used. Crude SiHMA (20 g), made using the Ir catalyzed hydrosilylation method described in U.S. patent Ser. No. 10/280,265B2, was loaded into a 50 mL flask. Vacuum was applied to reduce the pressure to 1 mmHg and kept at this level. The flask was heated at 70° C. for 1 h to remove the low boilers. The residual material was further distilled under <0.1 mmHg at 76-87° C. for 1 h and a clear distillate (SiHMA) was collected. The bottoms were gelled, suggesting poor stability of the material made from the Ir-catalyzed hydrosilylation, as compared to that from the cohydrolysis route described herein. 10.49 g SiHMA (89% pure, which was less pure than the 98% purity from the cohydrolysis) was obtained, with a yield of 53%, lower than the 70% yield of the cohydrolysis route.

### Problem to be Addressed

The method for making the asymmetric (meth)acrylate functional diorganosiloxane via hydrosilylation reaction of an organohydrogensiloxane oligomer and a carboxylic acid alkenyl ester, in the presence of a hydrosilylation reaction catalyst such as Pt or Ir, suffers from the drawback that the resulting crude reaction product is unstable. The hydrosilylation reaction catalyst can cause instability when the crude product is exposed to conditions to purify the asymmetric (meth)acrylate functional diorganosiloxane, e.g., when heating to strip or distill. Without wishing to be bound by theory, it is thought that the hydrosilylation reaction catalyst can cause gelation potentially from the reaction between the silicon bonded hydrogen atom and the (meth)acrylate-functional group. This instability can reduce yield because the desired product may be consumed during purification and produce undesirable by-products. If an inhibitor is used to prevent this instability, this adds cost and still may be insufficient to prevent instability to a sufficient degree for the process to prevent yield loss

### Solution

The method described herein provides the asymmetric (meth)acrylate-functional diorganosiloxane without significant yield loss or loss of selectivity.

### Definitions and Usage of Terms

All amounts, ratios, and percentages herein are by weight, unless otherwise indicated. The SUMMARY and ABSTRACT are hereby incorporated by reference. The articles, “a”, “an”, and “the” each refer to one or more, unless otherwise indicated by the context of the specification. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The abbreviations used herein have the definitions in Table 3.

TABLE 3
Abbreviations

| Abbreviation | Definition |
|---|---|
| Br | Bromo, bromine |
| ° C. | degrees Celsius |
| Cl | Chloro, chlorine |
| DSC | Dow Silicones Corporation of Midland, Michigan, USA |
| F | Fluoro, fluorine |
| g | gram |
| GC | Gas chromatography |
| h | hour |
| I | Iodo, iodine |
| Ir | iridium |
| m | meter |
| (meth)acryl- | class of compound or moiety including an acryl- group, |
| | a methacryl- group, or both. |
| min | minute |
| mL | milliliter |
| mmHg | millimeters of mercury |
| mol | mole |
| PDMS | polydimethylsiloxane |
| Pt | platinum |
| SiHMA | 2-propenoic acid, 2-methyl, 3-(1,1,3,3-tetramethyl-1- |
| | 1disiloxanyl)propyl ester |
| μL | microliter |

The invention has been described in an illustrative manner, and it is to be understood that the terminology which has been used is intended to be in the nature of words of description rather than of limitation. With respect to any Markush groups relied upon herein for describing particular features or aspects, different, special, and/or unexpected results may be obtained from each member of the respective Markush group independent from all other Markush members. Each member of a Markush group may be relied upon individually and or in combination and provides adequate support for specific embodiments within the scope of the appended claims.

### Test Methods

GC method. The chromatographic equipment consisted of a Hewlett Packard 5890 Series II GC equipped with a flame ionization detector and Hewlett Packard 6890 Series Autoinjector. The separation was made with a 30 m HP-5 column, with 78 mL/min helium flow and 1.05 mL/min column flow. The samples were prepared as 100 μL in 1 mL dichloromethane. An injection volume of 2 μL was used, with an injector temperature of 180° C. and a detector temperature of 300° C., and data was collected for 36.33 minutes. The oven method consisted of holding an initial temperature of 40° C. for 1 minute, followed by a ramp of 5° C./min to 150° C., a ramp of 15° C./min to 275° C., ending with holding the final temperature of 275° C. for 5 minutes.

NMR. Proton (1H) nuclear magnetic resonance (NMR) spectra were recorded on an Agilent 400-MR NMR spectrometer operating at 400 MHZ (mi-MR-05). Peak frequencies are recorded in ppm. 1H samples were run with 100 μL sample in 1 mL deuterated chloroform (CDCl₃). Spectra were analyzed using Mnova software.

1. A method for making an asymmetric (meth)acrylate-functional diorganosiloxane comprises:
(1) cohydrolysis of starting materials in a single reactor, where the starting materials consist essentially of
(A) a (meth)acryl-functional silane of formula R¹R²₂SiX, where R¹ is a (meth)acryloxyalkyl group, each R² is an independently selected alkyl group, and X is independently selected from the group consisting of a halogen atom and an alkoxy group;
(B) a diorganohydridohalosilane of formula R²₂HSiX, where each R² is an independently selected alkyl group, and
(C) water;
thereby forming a forms a product comprising a siloxane layer and an aqueous layer, where the siloxane layer comprises a cohydrolysis product comprising the asymmetric (meth)acrylate-functional diorganosiloxane and a side product.

2. The method of claim 1, where (A) the (meth)acryl-functional silane and (B) the diorganohydridohalosilane are added to (C) the water over a period of time.

3. The method of claim 1, where step (1) is performed at a temperature >0 to <10° ° C.

4. The method of claim 1, further comprising: (2) separating the siloxane layer and the aqueous layer, and washing the cohydrolysis product with water after step (1).

5. The method of claim 4, further comprising (3) adding a neutralizing agent during or after step (2).

6. The method of claim 1, further comprising drying the cohydrolysis product.

7. The method of claim 1, further comprising stripping or distilling the cohydrolysis product.

8. The method of claim 1, where each R¹ is (meth)acryloxypropyl, each R² is methyl, and each X is chloro or methoxy.

9. The method of claim 1, where the asymmetric (meth)acrylate-functional diorganosiloxane has formula: 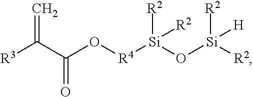
where R², is as described above, each R³ is independently selected from the group consisting of H and methyl, and each R⁴ is an independently selected divalent hydrocarbon group.

10. The method of claim 1, where the side product is selected from the group consisting of: 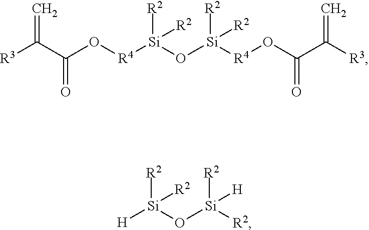
or a combination of both, where R² is as described above,
each R³ is independently selected from the group consisting of H and methyl, and
each R⁴ is an independently selected divalent hydrocarbon group.

11.-13. (canceled)

14. The method of claim 2, further comprising drying the cohydrolysis product.

15. The method of claim 2, further comprising stripping or distilling the cohydrolysis product.

16. The method of claim 2, where each R¹ is (meth)acryloxypropyl, each R² is methyl, and each X is chloro or methoxy.

17. The method of claim 2, where the asymmetric (meth)acrylate-functional diorganosiloxane has formula: 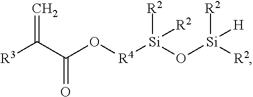
where R², is as described above, each R³ is independently selected from the group consisting of H and methyl, and each R⁴ is an independently selected divalent hydrocarbon group.

18. The method of claim 2, where the side product is selected from the group consisting of: 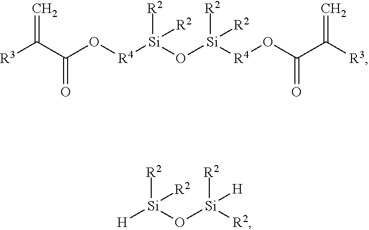
or a combination of both, where R² is as described above,
each R³ is independently selected from the group consisting of H and methyl, and
each R⁴ is an independently selected divalent hydrocarbon group.

19. The method of claim 5, further comprising drying the cohydrolysis product.

20. The method of claim 5, further comprising stripping or distilling the cohydrolysis product.

21. The method of claim 5, where each R¹ is (meth)acryloxypropyl, each R² is methyl, and each X is chloro or methoxy.

22. The method of claim 5, where the asymmetric (meth)acrylate-functional diorganosiloxane has formula: 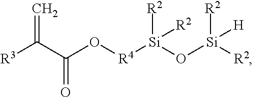
where R², is as described above, each R³ is independently selected from the group consisting of H and methyl, and each R⁴ is an independently selected divalent hydrocarbon group.

23. The method of claim 5, where the side product is selected from the group consisting of: 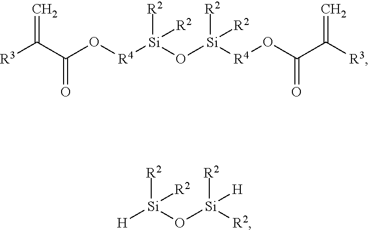
or a combination of both, where R² is as described above,
each R³ is independently selected from the group consisting of H and methyl, and
each R⁴ is an independently selected divalent hydrocarbon group.
